(19) United States
(12) Patent Application Publication
(10) Pub. No.: US 2015/0063638 A1
(43) Pub. Date: Mar. 5, 2015

(54) COMMODITY REGISTRATION APPARATUS AND COMMODITY REGISTRATION METHOD

(71) Applicant: TOSHIBA TEC KABUSHIKI KAISHA, Tokyo (JP)

(72) Inventor: Tomonari Kakino, Fuji (JP)

(21) Appl. No.: 14/468,470

(22) Filed: Aug. 26, 2014

(30) Foreign Application Priority Data
Aug. 30, 2013 (JP) 2013-179384

(51) Int. Cl. G06K 9/00

(52) U.S. Cl. CPC G06K 9/00671
USPC 382/103

(57) ABSTRACT

In accordance with one embodiment, a commodity registration apparatus recognizes and registers a commodity on the basis of a commodity image captured by an image capturing section, and detects whether or not there is a barcode in the captured commodity image. In a case in which a barcode is detected, the commodity-recognition registration based on the captured commodity image is restrained. In this way, it is prevented that the commodity registration processing based on image recognition is carried out in spite that a barcode is attached, which can reduce the waste of processing time.

### CROSS-REFERENCE TO RELATED APPLICATION

This application is based upon and claims the benefit of priority from Japanese Patent Application No. 2013-179384, filed Aug. 30, 2013, the entire contents of which are incorporated herein by reference.

### FIELD

Embodiments described herein relate to a commodity registration apparatus, which photographs a commodity with an image capturing module and carries out commodity registration on the basis of the captured image, and a commodity registration method.

### BACKGROUND

In a conventional commodity registration apparatus, an operator switches between two modes (a barcode reading mode and an image recognition mode) to carryout commodity registration. In a case of registering a commodity attached with a barcode, the operator switches the commodity registration apparatus to the barcode reading mode to enable the commodity registration apparatus to read the commodity attached with a barcode to carry out commodity registration. On the other hand, in a case of registering a commodity attached with no barcode, the operator switches the commodity registration apparatus to the image recognition mode to enable the commodity registration apparatus to read the commodity to carry out commodity registration.

In a case of carrying out commodity registration with the conventional technology, the operator needs to visually confirm the existence of barcode on the commodity and then switch between the modes, and if the operator overlooks the barcode of the commodity attached with a barcode, there is a problem that the commodity is registered incorrectly in the image recognition mode. As a result, the psychological burden of the operator is increased because the operator has to check the existence of barcode carefully.

### BRIEF DESCRIPTION OF THE DRAWINGS

FIG. 1 is a perspective view illustrating the appearance of a commodity registration apparatus according to one embodiment;

FIG. 2 is a block diagram illustrating the hardware constitution of the registration apparatus shown in FIG. 1;

FIG. 3 is an illustration diagram illustrating one example of a PLU file;

FIG. 4 is a flowchart illustrating processing operations according to the embodiment; and

FIG. 5 is a flowchart illustrating detailed processing operations of part of FIG. 4.

### DETAILED DESCRIPTION

In accordance with one embodiment, a commodity registration apparatus comprises an image capturing module configured to photograph a commodity to obtain an image of the commodity; a commodity-recognition registration module configured to recognize and register the commodity based on the image; and an optical code detection module configured to detect the existence of optical code based on the image; wherein the commodity registration by the commodity-recognition registration module is restrained in a case in which the optical code is detected in the image.

In accordance with one embodiment, a commodity registration method includes photographing a commodity to obtain an image of the commodity; recognizing and registering the commodity based on the image; and detecting the existence of optical code based on the image; wherein the commodity registration based on the image is restrained in a case in which the optical code is detected in the image.

Hereinafter, the embodiment is described in detail with reference to the accompanying drawings.

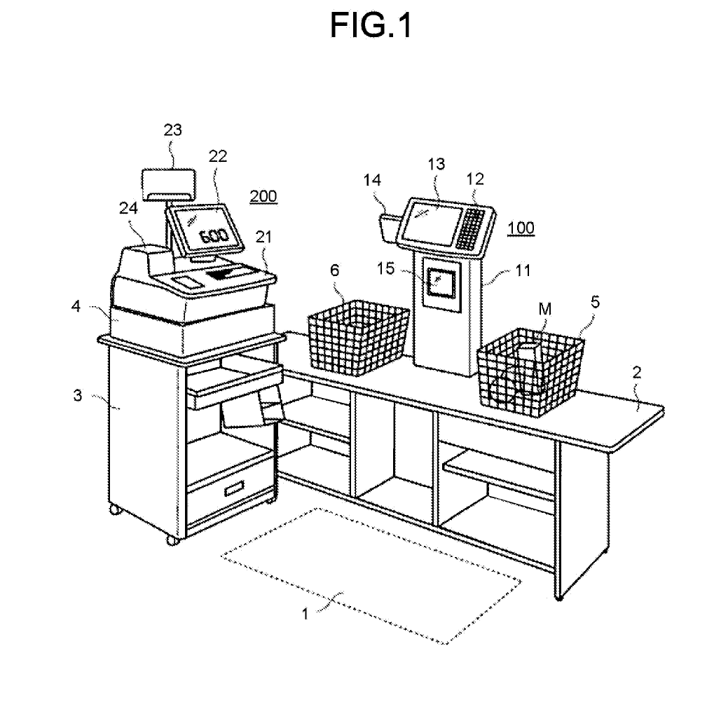

FIG. 1 is a perspective view illustrating the appearance of the commodity registration apparatus according to the embodiment. A register arranged in a supermarket and the like can be listed as an application example of the commodity registration apparatus. The register is provided with a registration apparatus 100 used in the commodity registration and a POS (Point Of Sales) terminal 200 used in the settlement of the registered commodity, which are arranged facing a work area 1 of a cashier serving as a shop clerk in charge of checkout job.

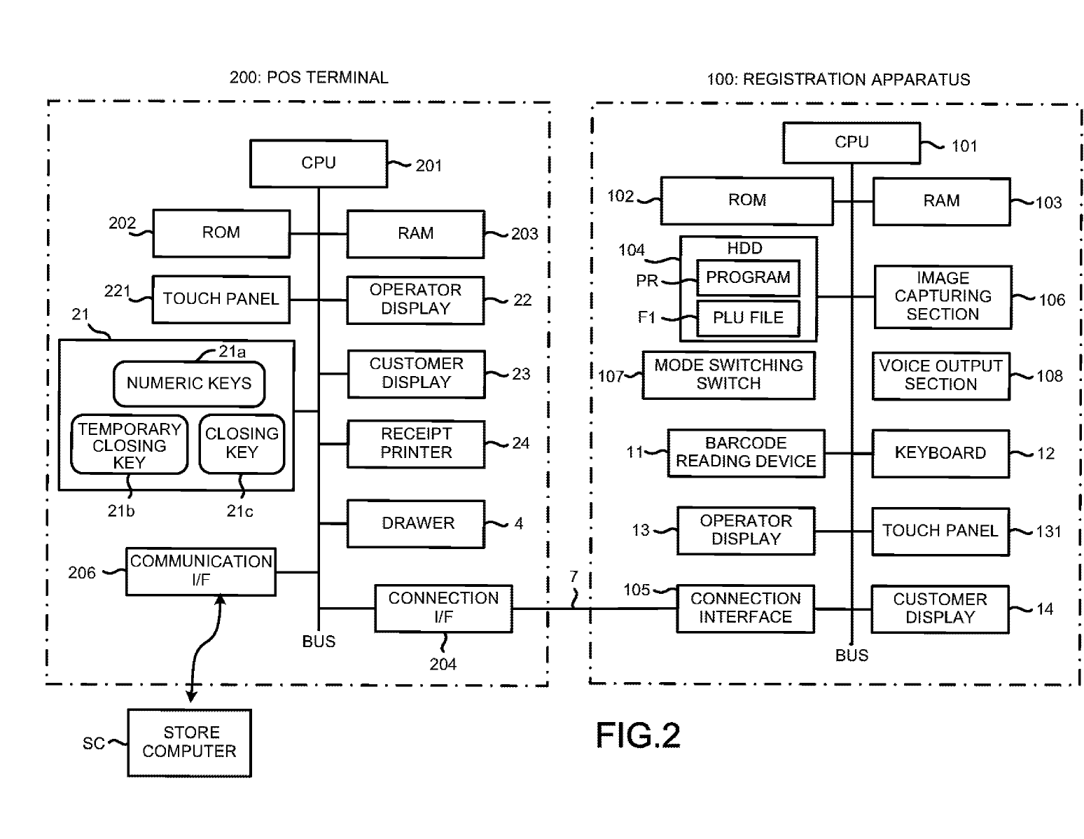

The registration apparatus 100 is fixed on the checkout counter 2. The POS terminal 200 is carried on a register table 3 through a drawer 4. The registration apparatus 100 and the POS terminal 200 are connected with each other through a communication cable 7 (refer to FIG. 2).

The checkout counter 2 is formed in an elongated shape along a customer path located at the rear side thereof. The register table 3 is arranged at the nearer side of the checkout counter 2 at a substantially right angle to the checkout counter 2. Specifically, the register table 3 is located at the end part of the checkout counter 2 at the downstream side of the movement direction of a customer moving along the checkout counter 2. Therefore, the checkout counter 2 and the register table 3 are arranged in an L-shape to define the work area 1 for a casher.

The POS terminal 200 is provided with a keyboard 21, an operator display 22, a customer display 23, a receipt printer 24 and the like as devices required to carry out commodity settlement.

The registration apparatus 100 is provided with a barcode reading device 11, a keyboard 12, an operator display 13, a customer display 14 and the like as devices required to carry out commodity registration.

The barcode reading device 11, which is formed in a cuboid box shape, is vertically arranged at the approximate center of the checkout counter 2 in such a manner that the long axis thereof is perpendicular to the surface of the checkout counter 2. The barcode reading device 11 can also read a QR code (registered trademark) and the like serving as an optical code as well as the barcode serving as an optical code. No specific limitation is given to the barcode reading device as long as it can read the code attached to the commodity.

The keyboard 12 and the operator display 13 are arranged at the upper portion of the barcode reading device 11 in the manner of being directed to the work area 1. The customer display 14 is arranged at the upper portion of the barcode reading device 11 in the manner of being directed to the side opposite to the work area 1.

A rectangular-shaped reading frame 15 is formed in one surface of the barcode reading device 11 facing the work area 1. LED light sources (not shown) are arranged at the upper side and the lower side of the reading frame 15 as irradiation modules for irradiating the commodity held in a barcode reading area surrounded by the reading frame 15.

A first upper surface portion of the checkout counter 2 at the upstream side thereof through the barcode reading device 11 in the customer movement direction serves as a space for placing a shopping container 5 in which a commodity M purchased by a customer is held. On the other side, a second upper surface portion at the downstream side through the barcode reading device 11 serves as an another space for placing a shopping container 6 in which a commodity M registered by the barcode reading device 11 is held.

The cashier in the work area 1 takes out the commodity M held in the shopping container 5 one by one and holds the surface of the commodity M on which a barcode is attached over the reading frame 15 of the barcode reading device 11. If the barcode is recognized by the barcode reading device 11, the commodity M is put into the shopping container 6. The foregoing work is carried out repeatedly for each commodity M held in the shopping container 5, and after the work is completed, the POS terminal 200 is operated to carry out settlement processing.

FIG. 2 is a block diagram illustrating the hardware constitutions of the registration apparatus 100 and the POS terminal 200.

The registration apparatus 100 adopts a technology of general object recognition for detecting a general object such as a “car” or “vegetables” from an image. In such a technology, the category and the like of a target object is recognized from image data obtained by photographing the object with a camera.

The registration apparatus 100 carries a CPU (Central Processing Unit) 101 as a control section main body. The CPU 101 extracts appearance feature amount of the object contained in the image from image data. The CPU 101 compares the extracted appearance feature amount with the feature amount data of a reference image registered in a recognition dictionary file to calculate a similarity degree, and then recognizes the category and the like of the object based on the similarity degree. The technology for recognizing the object contained in an image is disclosed in, for example, Japanese Unexamined Patent Application Publication No. 2013-120482.

In addition, the technology carrying out the image recognition by area division of the image for each object is described in, for example, Japanese Unexamined Patent Application Publication No. 2009-123234 and Re-publication of PCT International Publication No.2007/069393.

The CPU 101 is connected with an ROM (Read Only Memory) 102, an RAM (Random Access Memory) 103, an HDD (Hard Disk Drive) 104 and a connection interface 105 through a bus line such as an address bus, a data bus and the like.

The CPU 101 is further connected with an image capturing section 106, a mode switching switch 107, a voice output section 108, the barcode reading device 11, the keyboard 12, the operator display 13, a touch panel 131 and the customer display 14 through various input/output circuits (not shown). The CPU 101 is connected, via the connection interface 105, with a connection interface 204 in the POS terminal 200 to be capable of communicating.

The ROM 102 stores programs executed by the CPU 101. The RAM 103 functions as a main storage section of the registration apparatus 100. The HDD 104 functions as an auxiliary storage section. The HDD 104 may be a SSD (Solid State Drive) and the like.

The HDD 104 stores a program PR and various files of the registration apparatus 100 and the POS terminal 200. When the registration apparatus 100 is started, all or part of the program and various files stored in the HDD 104 are developed on the RAM 103 and then executed by the CPU 101 in sequence.

The program PR for the commodity sales data processing is one example of the program stored in the HDD 104. A PLU file F1, in which commodity data containing at least the commodity code and the commodity name of a commodity transmitted and stored from a store computer SC is registered, is one example of the file stored in the HDD 104.

The PLU file F1 is a commodity file in which the association between the information relating to the sales registration of the commodity M and the captured image of the commodity M is set for each commodity M displayed and sold in the store.

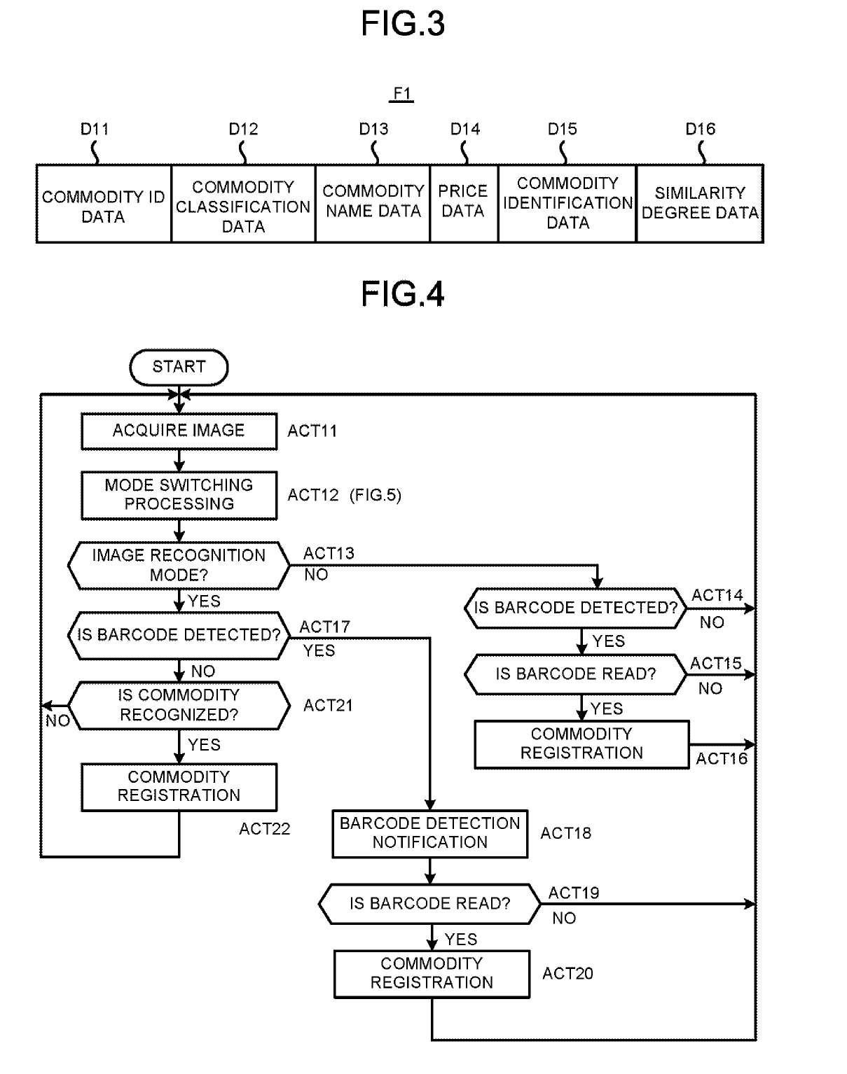

As shown in FIG. 3, commodity ID data D11, commodity classification data D12, commodity name data D13, price data D14, commodity identification data D15 and similarity degree data D16 are stored in the PLU file F1 for each commodity.

The commodity ID data D11 is uniquely assigned data for specifying the commodity M.

The commodity classification data D12 is used to specify the classification of the commodity to which the commodity M belongs.

The commodity name data D13 is used to specify the commodity name of the commodity M.

The price data D14 is data relating to the commodity M, such as the unit price, discount and the like.

The commodity identification data D15 is used to specify the feature amount data (data relating to the hue, appearance shape, surface concave-convex state and the like) for image recognition for specifying the commodity M from the captured image, and a code symbol such as a barcode assigned to the commodity M.

The similarity degree data D16 is the lower limit value of a threshold value in a case of specifying as the commodity M in the image recognition.

The data constitution of the PLU file F1 is not limited to the D11-D16 shown in FIG. 3. For example, a typical commodity image may be stored as the commodity identification data.

The image capturing section 106, which is an image capturing module for capturing an image, consists of illumination device using LED and the like, a camera using an image sensor such as a CMOS or a CCD, and the like. The operations of the image capturing section 106 are controlled by the CPU 101. The image capturing section 106 captures a motion image at a rate of, for example, 30 fps. The frame images (captured images) sequentially captured by the image capturing section 106 at a given frame rate are stored in the RAM 103 in sequence.

The mode switching switch 107 switches between an image recognition mode and a barcode reading mode. In the image recognition mode, the commodity is recognized on the basis of the image captured by the image capturing section 106, and in the barcode reading mode, the barcode is read to recognize the commodity. It is applicable that the mode switching switch 107 is arranged on the touch panel 131 to be operated.

The voice output section 108 gives a notification through a voice such as an alarm voice and the like under the control of the CPU 101. In a case in which the operator tries to read a commodity attached with a barcode while the reading mode is the image recognition mode, the voice output section 108 serves as an error notification module for notifying the operator of the error under the control of the CPU 101. The voice output section 108 consists of a voice circuit, a speaker and the like for issuing, for example, a preset alarm voice.

The operator display 13 can also be used as the touch panel 131. As to the touch panel 131 serving as a commodity registration key input module for carrying out commodity registration, the key which can be input by the operator through a touch operation is displayed on the operator display 13. The displayed key includes a PLU key for registering a commodity through one touch, a section key for combining a plurality of keys to register a commodity, an amount key and the like.

The CPU 101 is connected with the connection interface 105 which is connected with the connection interface 204 of the POS terminal 200 to enable the data transmission/reception with the POS terminal 200.

In a case in which it is detected that the PLU key is pressed according to the operation information of the touch panel 131, the CPU 101 sends the commodity code corresponding to the PLU key to the POS terminal 200. In a case in which it is detected that the section key or the amount key is pressed, the CPU 101 sends the key code of the key to the POS terminal 200, respectively.

The POS terminal 200 includes a CPU 201 serving as an information processing section for executing information processing. The CPU 201 executes various operations processing to control each section. The CPU 201 is connected with an ROM 202 and an RAM 203 through a bus line.

Though the HDD functioning as an auxiliary storage section of the RAM 203 in the POS terminal 200 is shared with the HDD 104 of the registration apparatus 100 in the present embodiment, the present invention is not limited to this, and a dedicated HDD may be arranged in the POS terminal 200.

The HDD 104 stores a program PR and various files of the POS terminal 200. When the registration apparatus 100 is started, all or part of the program and various files stored in the HDD 104 are developed on the RAM 203 and then executed by the CPU 201 in sequence. The HDD 104 can be read by the POS terminal 200 through the connection interface 204.

The CPU 201 of the POS terminal 200 is connected, through an input/output circuit (not shown), with a communication interface 206 for executing data communication with the store computer SC. The store computer SC is arranged in the backyard and the like of a store. The HDD in the store computer SC stores the FLU file Fl to be transmitted to the POS terminal 200. The store computer SC and the communication interface 206 for executing data communication may be arranged at the side of the registration apparatus 100.

The CPU 201 of the POS terminal 200 is connected, through various input/output circuits (none is shown), with the drawer 4, the keyboard 21, the operator display 22, the touch panel 221, the customer display 23 and the like which are controlled by the CPU 201. The touch panel 221 is similar to the touch panel 131 of the registration apparatus 100, and the key, which can be input by the operator through a touch operation, is also displayed on the operator display 22.

The keyboard 21 includes numeric keys 21a on which numeric characters such as ‘1’, ‘2’, ‘3’ . . . and operators such as multiplying operator ‘*’ are displayed, temporary closing key 21b and a closing key 21c.

The CPU 201 of the POS terminal 200 is connected with the connection interface 204 which enables the data transmission/reception with the registration apparatus 100. The connection interface 204 is connected with the registration apparatus 100. The CPU 201 is further connected with the receipt printer 24 for carrying out printing on a receipt and the like. The POS terminal 200 prints the transaction content of one transaction on a receipt under the control of the CPU 201.

FIG. 4 is a flowchart illustrating the processing of the CPU 101 for reducing the work burden of the operator when recognizing a commodity in the image recognition mode. The processing is started after the registration apparatus 100 is started.

First, the CPU 101 starts the image capturing section 106 to acquire an image. The frame images captured by the image capturing section 106 are stored in the RAM 103 in sequence (ACT 11).

The CPU 101 switches the reading modes based on the switch state of the mode switching switch 107 (ACT 12).

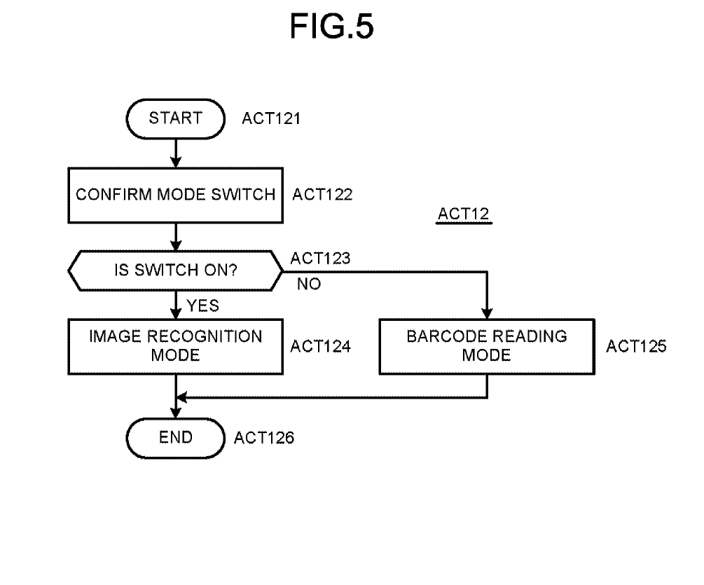

The reading mode switching processing in ACT 12 is described with reference to the flowchart in FIG. 5.

The reading mode switching processing in FIG. 5 is started as part (ACT 12) of the processing shown in FIG. 4 (ACT 121) The CPU 101 confirms the state of the mode switching switch 107 (ACT 122), and switches between the reading modes corresponding to the switch state of the mode switching switch 107 (ACT 123). In a case in which the mode switching switch 107 is “ON”, the reading mode is changed to the image recognition mode (ACT 124), while in a case in which the mode switching switch 107 is “OFF”, the reading mode is changed to the barcode reading mode (ACT 125). After the reading mode switching processing is ended, it returns to the main processing shown in FIG. 4 (ACT 126).

Next, the CPU 101 determines whether the reading mode is the image recognition mode or the barcode reading mode (ACT 13).

In a case of barcode reading mode (NO in ACT 13), the CPU 101 tries to detect the barcode using the image stored in the RAM 103 (ACT 14).

If the barcode is not detected (NO in ACT 14), ACT 11 is taken to acquire a next commodity image. If the barcode is detected (YES in ACT 14), the CPU 101 tries to read the barcode (ACT 15).

If the barcode is not read successfully (NO in ACT 15), ACT 11 is taken to acquire a next commodity image. If the barcode is read successfully (YES in ACT 15), the read commodity code is sent to the POS terminal 200 to carry out commodity registration processing (ACT 16). Then, ACT 11 is taken to acquire a next commodity image.

On the other hand, in a case in which the reading mode is the image recognition mode (YES in ACT 13), the CPU 101 tries to detect the barcode using the image stored in the RAM 103 (ACT 17). In addition, it is not necessary to detect the whole barcode in ACT 17, and it is applicable that part or half segment of the barcode is detected.

If the barcode is detected (YES in ACT 17), for example, a buzzer rings and an error is notified from the voice output section 108 to notify the operator that a barcode is detected (ACT 18). The error notification is not limited to a voice, and the error notification may be carried out by displaying an error message on the operator display 13. For example, in a place where a notification through voice is inconvenient, only an error message is displayed. In a case of displaying an error message, the error message is flashing so that the operator can recognize the error. It is also considered to carry out the error message notification through light or vibration.

After the error message notification, the CPU 101 tries to read the barcode (ACT 19).

If the barcode is not read successfully (NO in ACT 19), ACT 11 is taken to acquire a next commodity image. If the barcode is read successfully (YES in ACT 19), the read commodity code is sent to the POS terminal 200 to carry out commodity registration processing (ACT 20). Then, ACT 11 is taken to acquire a next commodity image.

If the barcode is not detected (NO in ACT 17), the CPU 101 takes ACT 21 to try commodity recognition.

If the commodity recognition is not successful (NO in ACT 21), ACT 11 is taken to acquire a next commodity image. If the commodity recognition is successful (YES in ACT 21), the commodity code equivalent to the recognized commodity is sent to the POS terminal 200 to carry out commodity registration processing (ACT 22). Then, ACT 11 is taken to acquire a next commodity image.

In this way, the probability that the commodity attached with a barcode is incorrectly registered through image recognition in the image recognition mode can be reduced. Through the error notification voice, the operator can easily know that the reading processing is carried out in an improper mode.

In the present embodiment, when recognizing a commodity in the image recognition mode, the commodity registration apparatus confirms the existence of barcode, which can reduce the occurrence of incorrect registration and the work burden of the operator.

The present invention is not limited to the embodiment described above. For example, in the processing of the CPU 101 when recognizing a commodity in the image recognition mode, the barcode reading processing is carried out in ACT 19 in the image recognition mode. However, the processing in ACT 19 is not necessary to be carried out, and it is applicable to only carry out the barcode detection notification processing in ACT 18.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity registration apparatus, comprising:
an image capturing module configured to photograph a commodity to obtain an image of the commodity;
a commodity-recognition registration module configured to recognize and register the commodity based on the image; and
an optical code detection module configured to detect the existence of optical code based on the image; wherein
the commodity registration by the commodity-recognition registration module is restrained in a case in which the optical code is detected in the image.

2. The commodity registration apparatus according to claim 1, further comprising:
an optical code detection notification module configured to notify that an optical code is detected from an image by the optical code detection module; wherein
the commodity registration by the commodity-recognition registration module is restrained and a notification is given by the optical code detection notification module in a case in which the optical code is detected in the image.

3. The commodity registration apparatus according to claim 2, wherein
the optical code detection notification module gives a notification to the operator through at least one of a voice and visual information on display.

4. The commodity registration apparatus according to claim 1, further comprising:
an optical code-reading registration module configured to read the optical code from an image and then register a corresponding commodity; wherein
the commodity registration by the commodity-recognition registration module is restrained, and the optical code is read and the corresponding commodity is registered by the optical code-reading registration module in a case in which the optical code is detected in the image.

5. The commodity registration apparatus according to claim 4, wherein
the commodity-recognition registration module and the optical code-reading registration module are switched automatically according to whether or not the optical code is detected in an image.

6. A commodity registration method, including:
recognizing and registering a commodity based on an image obtained by photographing the commodity; and
detecting the existence of optical code based on the image; wherein
the commodity registration based on the image is restrained in a case in which the optical code is detected in the image.
